(19) United States
(12) Patent Application Publication
(10) Pub. No.: US 2005/0136221 A1
(43) Pub. Date: Jun. 23, 2005

(54) Multi-layer bed liner

(76) Inventor: Joseph G. Fabick JR., Madison, WI (US)

Correspondence Address: WELSH & KATZ, LTD, 120 S RIVERSIDE PLAZA, 22ND FLOOR, CHICAGO, IL, 60606, US

(21) Appl. No.: 10/744,989

(22) Filed: Dec. 23, 2003

(51) Int. Cl. B32B 3/00

(52) U.S. Cl. 428/156

(57) ABSTRACT

A method and apparatus are provided for protecting a cargo carrying area of a pickup truck where said cargo carrying area has a load bed, two opposing vertical side members and a vertical front member. The method includes the steps of providing first and second polymer compositions, said first polymer composition being dissimilar to the second polymer composition, pouring the first polymer composition over the load bed of the pickup and only over the load bed, said first polymer composition forming a lower layer with a smooth, substantially flat finish over the load bed and spraying the second polymer composition over the first polymer composition on the load bed and over opposing inside surfaces of the vertical side members and front member, said second polymer composition forming an upper layer of a textured, non-skid surface over the load bed, the inside surfaces of the two opposing vertical side surfaces and front member.

### FIELD OF THE INVENTION

The field of the invention relates to trucks and more particularly to protective materials for a load bed of pickup trucks, truck with a utility box, etc.

### BACKGROUND OF THE INVENTION

Bed liners for trucks are generally known. Bed liners are typically used to protect the metal box of the truck bed from scratches and dents.

Bed liners may be prefabricated for a particular application or may be provided in situ in the form of a coating that is applied to the bed of the truck. Prefabricated liners are typically vacuum formed of polyethylene, polypropylene, or polyvinylchloride.

Because of the variability in manufacturing processes and a desire of manufactures to make prefabricated liners to fit multiple vehicles, prefabricated liners usually assume a loose fit in a bed of a vehicle. However, a loose fit between a liner and a truck bed allows movement. Movement of the bed liner within the truck bed has the potential to wear away the paint on the truck bed, thereby defeating the purpose of having a bed liner.

To accommodate the loose fit of the liner, prefabricated bed liners are often secured to the truck bed with screws and bolts. However screws and bolts require drilling holes. Drilling holes increases the potential for corrosion.

In situ bed liners are usually formed by spraying or pouring a polymer onto the truck bed. While sprayed-on liners have been known for some time, one prior art reference has taught that the same type of polymer may be poured onto a bed of the vehicle and also sprayed onto the sides of the bed. While the use of a single polymer has been relatively successful, it also represents a performance compromise. Because of the importance of safety and durability, a need exist for a truck liner that is durable yet safe for use under a variety of environmental conditions.

### SUMMARY

A method and apparatus are provided for protecting a cargo carrying area of a pickup truck where said cargo carrying area has a load bed, two opposing vertical side members and a vertical front member. The method includes the steps of providing first and second polymer compositions, said first polymer composition being dissimilar to the second polymer composition, pouring the first polymer composition over the load bed of the pickup and only over the load bed, said first polymer composition forming a lower layer with a smooth, substantially flat finish over the load bed and spraying the second polymer composition over the first polymer composition on the load bed and over opposing inside surfaces of the vertical side members and front member, said second polymer composition forming an upper layer of a textured, non-skid surface over the load bed, the inside surfaces of the two opposing vertical side surfaces and front member.

### BRIEF DESCRIPTION OF THE DRAWINGS

FIG. 1 depicts a multi-layer bed liner shown in a context of use in a pickup truck in accordance with an illustrated embodiment of the invention;

FIG. 2 depicts a cut-away view of the bed liner of FIG. 1; and

FIG. 3 depicts an end-dam that may be used to create the bed liner of FIG. 1.

### DETAILED DESCRIPTION OF AN ILLUSTRATED EMBODIMENT

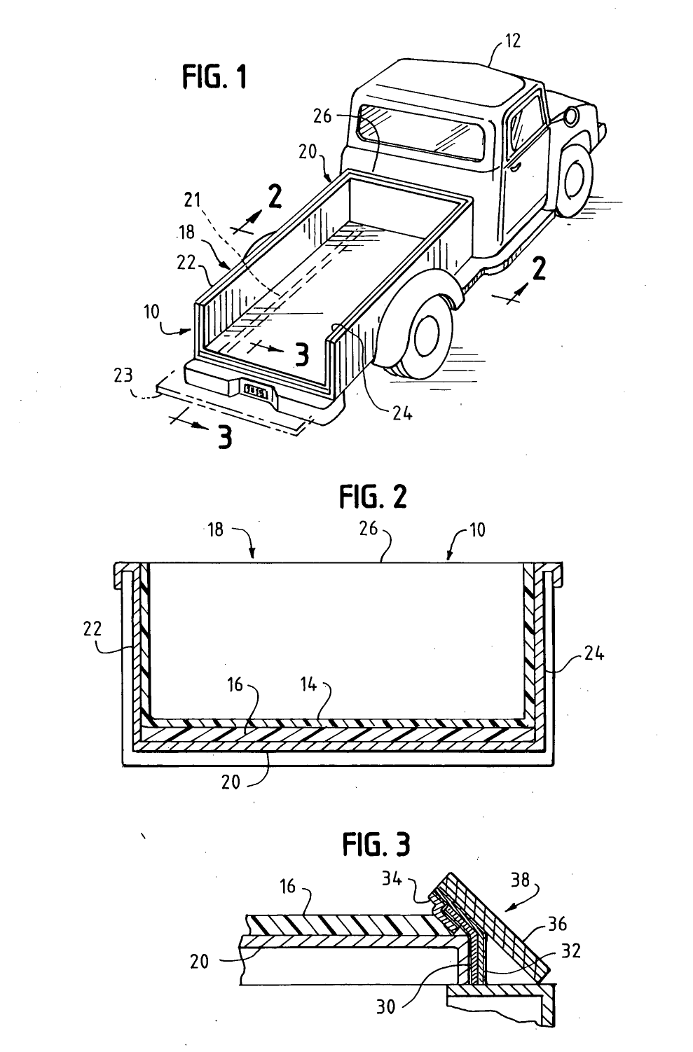

FIG. 1 is a perspective view of a pickup truck 12 having a bed liner 10 created in accordance with an illustrated embodiment of the invention. Under the illustrated embodiment, the bed liner 10 is made up of a number of dissimilar layers 14, 16 that together provide a functionality that was not available using prior art liners. As used herein, the term “layer” refers to one or more coatings or sub-layers of materials having substantially identical mechanical characteristics.

For example, prior art liners have strived to increase a density and toughness of those liners. However, increasing density and toughness also causes liners to have a greater hardness. Increasing harness results in liners that have a lower coefficient of friction and are therefore more slippery when wet.

On the other hand, liners that are relatively soft are more easily penetrated by sharp objects. Because of the compromise between hardness and slipperyness, prior bed liners have tended to be dangerous or prone to failure. Further, this problem has not been recognized by bed liner makers.

To solve this problem, the liner 10 of the pickup 12 combines a relatively soft layer 14 with a relatively hard layer 16. The layers 14, 16 may be formed of polymers that are dissimilar in performance. In general, the first and second layers 14, 16 may be formed from one or more of the group consisting of polyurethane, polyurea or a polyurethane/polyurea hybrid polymer. Under one preferred embodiment, the layers 14, 16 may be formed from a two-component reactive polymer.

As used herein, the term “dissimilar polymers” means polymers with substantially dissimilar mechanical characteristics in which the first polymer is harder in a finished state than the second polymer. For example, the lower layer may be a relatively hard material (e.g., Part #EP150 available from Engineered Polymers Int. of Madison Wis.) with a hardness rating in the Shore D scale of 50-80. The upper layer may be of a softer material (e.g., Part #EP121 from Engineered Polymers Int. of Madison Wis.) with a hardness rating on the Shore D scale of from 35-49. The use of dissimilar layers provides a performance that is not possible with either layer alone.

For example, the two-layer liner 10 of dissimilar polymers is superior to prior art liners because in order to offer a high coefficient of friction, the liner material had to be soft. However, as noted above, soft materials are easily penetrated by heavy or sharp objects. Penetration of the soft protective layer results in corrosion and ultimately to separation of the liner from the load bed. In contrast, the bottom layer 16 of the two-layer liner 10 is harder. The harder lower layer functions to provide penetration resistance while the softer upper layer 14 provide a coefficient of friction that the harder lower layer 16 cannot provide.

In addition, when subject to impact, the softer upper layer 14 has the added advantage of becoming a sacrificial layer that sloughs off under impact thereby absorbing the energy of the impact. The remaining lower layer 16 still protects the underlying metal from corrosion.

The two-layer design of dissimilar materials of the bed liner 10 is superior to removable bed liners because prior art removable liners have failed to protect the floor and sides of the load bed. The loose fit often resulted in rubbing and paint removal whenever rubbing occurs. In addition, any effort to install a 5^{th} wheel assembly or roll bar required cutting holes in the liners and usually results in water penetration and corrosion.

Prior art spray-on liners operated to protect the sides and floor of the load bed, but were easily damaged. Similarly, liners made of single polymer with pour-on floors and spray-on walls were either slippery when wet or subject to damage because of the inherent compromise that had to be made with regard to hardness.

Turning now to the liner 10, FIG. 1 shows a pickup 12 with a pickup box 18. The box 18 includes a load bed 20, a pair of opposing vertical side members (sides) 22, 24, a vertical front member (front) 26 and a tailgate 23.

FIG. 2 shows a cross-sectional view of the box 18 and liner 10. As shown, the liner 10 includes a first lower layer 16 that substantially covers the load bed 20. The liner 10 also includes a second, softer layer 14 that is disposed over the lower layer 16 and that also covers the inside surfaces of the opposing vertical side members 22, 24, the vertical front member 26 of the box 18 and the tailgate 23.

In order to create the liner 10, a number of preparatory steps may be followed. As a first step, the load bed 20 may be leveled. Leveling may be performed in both the side to side and also in the front to back directions. Hydraulic jacks and jackstands may be used to support the truck 12 in a leveled position.

Once the load bed 20 of the truck 12 has been leveled, the load bed 20 may be prepared to receive the lower layer 16. To prepare the bed 20, any opening in the bed 20 is sealed. Sealing may be performed by caulking any opening using an appropriate caulking material (e.g., 3M Window-Weld caulking). Caulking may be necessary because some of the seams are not finished and may allow the uncured lower layer 16 to leak through the bed 20. Normally, areas of the bed 20 that need caulking are located along the front panel (drain seam) and near the rear tailgate (i.e., the seam where the metal floor panel wraps over the back edge of the bed 20. In the corners of some truck boxes there is also a vertical seam that may need to be caulked as well.

As a further step, any drain holes present in the box 18 may be sealed. Sealing may be performed from the underside of the box 18 by placing masking tap over each drain hole.

In addition, a dam 38 (FIG. 3) may be created across the open rear end (tailgate area) of the box 18. The dam may be created by first applying a number of strips 30, 32 of 2 inch wide masking tape across the rear opening of the box 20 with opposing ends of the strips attached to the rear edges of the opposing vertical sides 22, 24 and with approximately 1 inch of the 2 inch wide strip attached to the vertical end of the load bed 20 along the width of the load bed. In effect, the making tape forms a dam approximately 1 inch high with a sticky side of the tape facing into the box 20.

To complete the dam 38, an additional strip of masking tape 34 may be applied from the inside of the box 20 to the dam with the sticky side of the additional strip 34 engaging the sticky side of the previously applied strips 30, 32. The dam 38 may be completed by laying a strip of flat material (e.g., plywood, metal, plastic, etc.) 36 across the opening with a lower, first end of the plywood 36 supported by the bumper 28 of the pickup and the additional strip of masking tape 34 is stuck to the underside of the second end of the plywood 36 as shown in FIG. 3. The weight of the plywood 36 causes the dam 38 to assume an appropriate angle with respect to the bed 20. Under one illustrated embodiments, an angle of 45 degrees may be used. Other angles may be used as appropriate to the circumstances.

The dam 38 inclined at an angle of 45 degrees provides at least two benefits. First, the dam 38 prevents the lower layer 16 from extending into the area of the tailgate of the pickup and preventing the proper closing of the tailgate. Second, the 45 degree angle functions to avoid trapping of debris between the-liner 10 and the tailgate and to allow the free flow of water out of the box 18.

Following installation of the dam 38, the lower layer 16 may be created. The lower layer 16 may be created using a low pressure dispensing gun (e.g., Part #550-100/200 available from TAH Industries, Inc. of Robbinville, N.J.). The low pressure dispensing gun may be coupled to a set of proportioning pumps (e.g., a Part #VH-3000 Plural Component High Pressure Metering Unit from Gusmer®, Lakewood, N.J.). The proportioning pumps transfer the required amounts of the A and B components of the lower layer 16 to a spiral mixer (e.g., a Series 160 Spiral Mixer with Bell Nozzle, available from TAH Industries, Inc. of Robbinsville, N.J.) attached to a manifold of the dispensing gun. The mixer should have a mixing element diameter of about 0.370 to 0.500 inches diameter and should contain about 36 to 40 mixing elements.

The proportioning pumps may be adjusted to provide a proportioning pressure of from 250 to 900 psi. Under these conditions, the spiral mixer may thoroughly mix the A and B components of the lower layer before application to the bed 20 of the pickup 12.

The lower layer 16 may be created using a two stage process. In the first stage, a first portion (sub-layer) of the lower layer 16 is poured into the spaces between the longitudinal ribs 21 that are present on the load bed 20 of the pickup 12. Since the ribs on some trucks are typically one-quarter inch high, the first sub-layer of the lower layer 16 is also approximately one-quarter inch thick between the ribs. Trucks with ridges of greater than one-quarter inch would have a first portion that is the same depth as the height of the ridge. The first sub-layer may be poured from front to back of the bed 20 making sure that the mixed A and B components flow under the edge of the dam 38. The first sub-layer may be poured to a depth such that the first portion substantially fills the spaces between the ribs 21 and is flush with a top surface of the ridges.

Once the first portion has cured, a second sub-layer is poured over the first sub-layer and the ribs. The second sublayer may be poured using the low pressure dispensing gun, proportioning pumps and spiral mixer described above. Application of the second sub-layer may be performed from front to back, but in this case using a side-to-side motion covering the entire bed 20 from one sidewall 22 to the other sidewall 24 using a sweeping motion.

Alternatively, the second sub-layer may be continuously poured following a simple serpentine path starting at the front of the truck and progressing backwards. The depth of the second sub-layer may be controlled by the speed of progression and by the proximity of adjacent lateral tracks. For example, a technition may allow each lateral path across the bed 20 to have a spacing of 3 inches in the front-to-back direction to form a relatively thick second sub-layer a spacing of 6 inches to allow for a relatively thin second portion. In general, the depth of the lower layer 16 may be selected based upon the static and shock loading that the liner 10 is expected to absorb.

In another alternative, the lower layer 16 may be poured in a single step. However, when poured in a single step, the polymer selected would be expected to have a longer hardening time to allow the single layer to self-level before hardening.

The first and second sub-layer together form the lower layer 16. The lower layer 16 may be approximately one-half inch thick between the ribs and one-quarter inch thick over the ribs.

Following the hardening of the lower layer 16, the upper layer 14 may be installed. The upper layer 14 may be formed using a spray gun (e.g., a Probler® gun available from Glas-Craft® of Indianapolis, Ind.) coupled to the proportioning pumps discussed above. The A and B components of the upper layer 14 may be heated to an appropriate temperature (e.g., between 100 and 150° F.) and the proportioning pumps may be adjusted to a pressure of between 800 and 2500 psi. Other pressures and temperatures may be used as appropriate to the polymer and conditions of application.

Mixing of the A and B components of the upper layer 14 occurs just prior to exiting a manifold of the spray gun. The high pressure provided by the proportioning pumps ensure complete mixing of the A and B components prior to deposition on the truck 12.

The upper layer 14 may be installed by spraying the bed 20, the opposing sidewalls 22, 24 and the front section 26. The tailgate 23 may be removed and sprayed as part of a separate process. The upper layer 14 may sprayed to a depth of approximately one-eighth inch. Other depths may be used as appropriate to the circumstances.

The spraying and particular composition of the upper layer 14 results in a textured surface that presents a substantially increased surface area that resists slippage of personnel working in or loads placed on the load bed. The harder lower layer resists damage under even the most challenging working environments.

A specific embodiment of method and apparatus for protecting a truck bed has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of protecting a cargo carrying area of a pickup truck where said cargo carrying area has a load bed, two opposing vertical side members, a vertical front member and a tailgate, said method comprising the steps of:
providing first and second polymer compositions, said first polymer composition being dissimilar to the second polymer composition;
pouring the first polymer composition over the load bed of the pickup and only over the load bed, said first polymer composition forming a lower layer with a smooth, substantially flat finish over the load bed; and
spraying the second polymer composition over the first polymer composition on the load bed and over opposing inside surfaces of the vertical side members and over the front member, said second polymer composition forming an upper layer of a textured, non-skid surface over the load bed, the inside surfaces of the two opposing vertical side surfaces, front member and tailgate.

2. The method of protecting the cargo carry area as in claim 1 wherein the lower layer further comprises a polymer that has a higher relatively hardness than the upper layer.

3. The method of protecting the cargo carry area as in claim 1 wherein the lower layer further comprises a thickness of from one-quarter to one-half inch.

4. The method of protecting the cargo carry area as in claim 1 wherein the upper layer further comprises a relatively constant thickness of one-eighth inch.

5. The method of protecting the cargo area as in claim 1 wherein the lower layer further comprises a relatively constant thickness except along a rear marginal edge of the load bed.

6. The method of protecting the cargo area as in claim 1 wherein the upper layer further comprises a relatively constant thickness except along a rear marginal edge of the load bed.

7. The method of protecting the cargo area as in claim 1 further comprising installing the lower layer as first and second sub-layers, said first sub-layer being disposed between a set of ribs in the load bed and the second layer being disposed on top of the first sub-layer and ribs, said first sub-layer being allowed to harden before the second sub-layer is disposed on top of the first sub-layer.

8. The method of protecting the cargo area as in claim 1 wherein the lower layer further comprises a tapered thickness along a rear marginal edge of the load bed.

9. The method of protecting the cargo area as in claim 1 wherein the tapered thickness further comprises a 45 degree taper.

10. The method of protecting the cargo area as in claim 1 further comprising establishing a temporary dam along the rear marginal edge before the lower layer is poured, said dam remaining in place until the lower layer has hardened.

11. The method of protecting the cargo area as in claim 10 wherein the temporary dam further comprises a 45 degree angle with respect to the load bed.

12. A bed liner for protecting a cargo carrying area of a pickup truck where said cargo carrying area has a load bed, two opposing vertical side members and a vertical front member, said bed liner comprising:
a first and second polymer compositions, said first polymer composition being dissimilar to the second polymer composition;
the first polymer composition disposed over the load bed of the pickup and only over the load bed, said first polymer composition forming a lower layer of a smooth, substantially flat finish over the load bed; and
the second polymer composition sprayed over the first polymer composition on the load bed and over opposing inside surfaces of the vertical side members and front member, said second polymer composition forming an upper layer of a textured, non-skid surface over the load bed, the inside surfaces of the two opposing vertical side surfaces and front member.

13. The bed liner for protecting the cargo carry area as in claim 12 wherein the lower layer further comprises a thickness of from one-quarter to one-half inch.

14. The bed liner for protecting the cargo carry area as in claim 12 wherein the upper layer further comprises a relatively constant thickness of one-eighth inch.

15. The bed liner for protecting the cargo area as in claim 12 wherein the lower layer further comprises a relatively constant thickness except along a rear marginal edge of the load bed.

16. The bed liner for protecting the cargo area as in claim 12 wherein the upper layer further comprises a relatively constant thickness except along a rear marginal edge of the load bed.

17. The bed liner for protecting the cargo area as in claim 12 wherein the lower layer further comprises first and second sub-layers, said first sub-layer being disposed between a set of ribs in the load bed and the second layer being disposed on top of the first sub-layer and ribs, said first sub-layer being allowed to harden before the second sub-layer is disposed on top of the first sub-layer.

18. The bed liner for protecting the cargo area as in claim 12 wherein the lower layer further comprises a tapered thickness along a rear marginal edge of the load bed.

19. The bed liner for protecting the cargo area as in claim 12 wherein the tapered thickness further comprises a 45 degree taper.

20. The bed liner for protecting the cargo area as in claim 12 further comprising establishing a temporary dam along the rear marginal edge before the lower layer is poured, said dam remaining in place until the lower layer has hardened.

21. The bed liner for protecting the cargo area as in claim 20 wherein the temporary dam further comprises a 45 degree angle with respect to the load bed.
